(19) United States
(12) Patent Application Publication
(10) Pub. No.: US 2015/0247539 A1
(43) Pub. Date: Sep. 3, 2015

(54) BEARINGS COORDINATION MECHANISMS AND SYSTEM

(71) Applicant: HARMONIC INNOVATION TECHNOLOGY CO., LTD., TAIPEI CITY (TW)

(72) Inventor: Chun-Shen YEH, TAIPEI CITY (TW)

(21) Appl. No.: 14/447,056

(22) Filed: Jul. 30, 2014

(30) Foreign Application Priority Data
Mar. 3, 2014 (TW) 103107082

(51) Int. Cl. F16D 41/06; F16D 41/04

(52) U.S. Cl. CPC F16D 41/06; F16D 41/04

(57) ABSTRACT

A bearings coordination mechanism comprises a first ring-shaped body, a flange and a second ring-shaped body. The first ring-shaped body forms a first accommodating space. The flange forms a second accommodating space and disposed in the first accommodating space. The second ring-shaped body is disposed in the second accommodating space. The outer side of the flange is coupled with an inner side of the first ring-shaped body in a single direction to form a first one-way bearing and an inner side of the flange is coupled with an outer side of the second ring-shaped body in the single direction to form a second one-way bearing. The structure of the present invention is capable to execute modes of operation in forward or backward direction. Moreover, the present invention further provides a bearings coordination system for executing forward and backward operation modes simultaneously.

### CROSS-REFERENCE TO RELATED APPLICATIONS

This Non-provisional application claims priority under 35 U.S.C. §119(a) on Patent Application No(s). 103107082 filed in Mar. 3, 2014, the entire contents of which are hereby incorporated by reference.

### FIELD OF THE INVENTION

This invention relates to a bearing and, more particularly, to bearings coordination mechanisms or systems using multiple power sources to output a single power source at a single flange by multiple one-way bearings, or using a single power source to output multiple power sources at the same flange by multiple one-way bearings.

### BACKGROUND OF THE INVENTION

In traditional mechanic system design; if an input transmission device and an output transmission device utilize multiple one-way bearings, it is necessary to design each of the one-way bearings individually in order to allow the one-way bearings to form an input shaft or an output shaft. Moreover, extra adapting junction parts are also required on the input shaft or the output shaft in order to switch between the input and output.

The assembly process of the input shaft and the output shaft is complicated and time consuming because more parts are involved, such as the above-mentioned adapting junction parts which result in increased cost of production. Moreover, it is not suitable to install in the transmission device, such as fitness equipments, vehicles, machinery tools and medical devices, due to the extremely large size of the assembled input shaft and output shaft.

### SUMMARY OF THE INVENTION

According to the above-mentioned, the present invention provides bearings coordination mechanism and system which solves the disadvantages of the prior art.

One of the purposes of the present invention is to provide a bearings coordination mechanism comprising a first ring-shaped body, a second ring-shaped body and a flange. The first ring-shaped body and the second ring-shaped body are coupled with the flange. The above-mentioned parts can be easily configured with an input power source and an output power source without any adapting junction parts.

The second purpose of the present invention is to allow multiple power sources to be outputted simultaneously or individually to the flange by the first ring-shaped body and the second ring-shaped body in a forward operation mode according to the bearings coordination mechanism. However, the flange is only towed by either the first ring-shaped body or the second ring-shaped body to output one force.

The third purpose of the present invention is to drive a single power source to tow the first ring-shaped body and the second ring-shaped body simultaneously via the flange and output a force from the first ring-shaped body and the second ring-shaped body in a backward operation mode according to the bearings coordination mechanism.

The fourth purpose of the present invention is that the first ring-shaped body is connected to an output roller and the output roller is connected to a brake unit in backward operation mode according to the bearings coordination mechanism. The brake unit decelerates the rotating speed of the output roller and indirectly decelerates the rotating speed of the flange via the first ring-shaped body. However, the decelerated flange will not affect the rotating speed of the second ring-shaped body.

The fifth purpose of the present invention is to provide a bearings coordination system for executing forward or backward operation modes simultaneously via the bearings coordination mechanism.

To achieve the above-mentioned purposes and other purposes, the present invention provides a bearings coordination mechanism comprising a first ring-shaped body, a flange and a second ring-shaped body. The first ring-shaped body forms a first accommodating space. The flange forms a second accommodating space. The flange is positioned in the first accommodating space, and the second ring-shaped body is positioned in the second accommodating space. The outer side of the flange is coupled with the inner side of the first ring-shaped body in a single direction to form a first one-way bearing, and the inner side of the flange is coupled with the outer side of the second ring-shaped body in the single direction to form a second one-way bearing.

To achieve the above-mentioned purposes and other purposes, the present invention provides a bearings coordination system comprising a first bearings coordination mechanism and a second bearings coordination mechanism. The first bearings coordination mechanism comprises a first ring-shaped body, a third ring-shaped body and a first flange. The first ring-shaped body is coupled with the first flange to form a first one-way bearing, and the third ring-shaped body is coupled with the first flange to form the second one-way bearing. The second bearings coordination mechanism comprises a second ring-shaped body, a fourth ring-shaped body and a second flange. The second ring-shaped body is coupled with the second flange to form the third one-way bearing, and the fourth ring-shaped body is coupled with the second flange to form the fourth one-way bearing, while the second flange is connected to the first flange. One of the first one-way bearing or the second one-way bearing outputs a first force to the second flange to drive the third one-way bearing to output a second force and to drive the fourth one-way bearing to output the third force.

Comparing to the prior art, not only the bearings coordination mechanism and system of the present invention can solve the disadvantage of using an additional adapting junction parts in the prior art, but also be applied onto the transmission devices, such as fitness equipment, vehicles, machinery tools and medical devices, to allow the transmission devices to accept a multiple power sources or convert a single power source to a multiple outputs.

The above-mentioned mechanism has several advantages, such as small size, easy maintenance, low cost due to the lack of adapting junction parts.

### BRIEF DESCRIPTION OF THE DRAWINGS

FIG. 1 is a schematic drawing showing a structure of a bearings coordination mechanism according to an embodiment of the present invention.

FIG. 2 is a schematic drawing showing a structure of a first one-way bearing in FIG. 1.

FIG. 3 is a schematic drawing showing a structure of a second one-way bearing in FIG. 1.

FIG. 4(a) is a schematic drawing showing a first forward operation mode according to an embodiment of the structure of the bearings coordination mechanism of the present invention; FIG. 4(b) is a schematic drawing showing a second forward operation mode according to an embodiment of the bearings coordination mechanism of the present invention; and FIG. 4(c) is a schematic drawing showing a third forward operation mode according to an embodiment of the bearings coordination mechanism of the present invention.

FIG. 5(a) is a schematic drawing showing a first backward operation mode according to an embodiment of the bearings coordination mechanism of the present invention; and FIG. 5(b) is a schematic drawing showing a second backward operation mode according to an embodiment of the bearings coordination mechanism of the present invention.

### DETAILED DESCRIPTION OF THE INVENTION

The advantages and features of the present invention can be further clarified by the following descriptions and attached drawings.

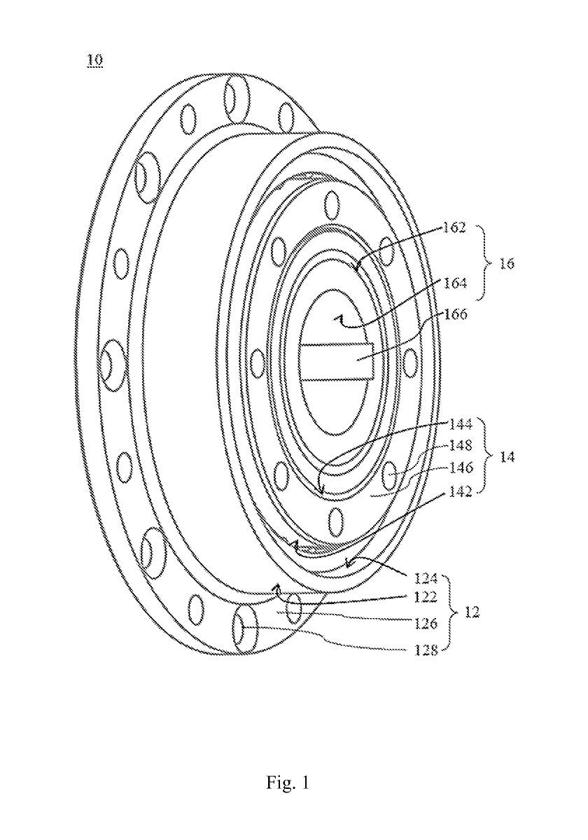

Please refer to FIG. 1, which is a schematic drawing showing a bearings coordination mechanism according to an embodiment of the present invention. In FIG. 1, the bearings coordination mechanism 10 can be applied onto a transmission device, such as electric bicycles, electric vehicles, machinery tools and medical devices, etc.

The bearings coordination mechanism 10 comprises a first ring-shaped body 12, a flange 14 and a second ring-shaped body 16.

The first ring-shaped body 12 is a circular ring-shaped body and forms a first accommodating space. In the figure, the first accommodating space is a hollow area for the first ring-shaped body 12. For easy description, the first ring-shaped body is defined to have a first outer side 122, a first inner side 124 and a disk side 126. In the current presentation, the disk side 126 of the first ring-shaped body 12 has multiple through holes 128, and the through holes can be used to connect to another input unit or output unit (not shown in the figure).

The flange 14 is positioned in the first accommodating space to allow the first ring-shaped body 12 to encompass flange 14. For easy description, the flange 14 is further defined to have a second outer side 142, a second inner side 144 and an upper side 146. Moreover, the upper side 146 of flange 14 has multiple blind holes 148. The blind holes 148 can be used to connect to another input unit or output unit (not shown in the figure). The second outer side 142 of the flange 14 is coupled with the first inner side 124 of the first ring-shaped body 12 to form a first one-way bearing and it will be described later. In addition, the flange 14 has a second accommodating space. In the figure, the second accommodating space is the hollow space of the flange 14.

The second ring-shaped body 16 is positioned in the second accommodating space. That is, the second ring-shaped body 16 is encompassed by flange 14. For easily description, the second ring-shaped body is further defined to have a third outer side 162 and a third inner side 164. Moreover, the third inner side 164 has a keyway 166. The keyway 166 can be used to connect to another input unit or output unit (not shown in the figure). The second inner side 144 of the flange 14 is coupled with the third outer side 162 of the second ring-shaped body 16 to form a second one-way bearing and it will be described later.

It is noted that the first one-way bearing forms when the first ring-shaped body 12 and the flange 14 are coupled together only due to the rotation in a certain direction for achieving the effect of mutual towing. The same principle of operation can also be adopted for the second one-way bearing.

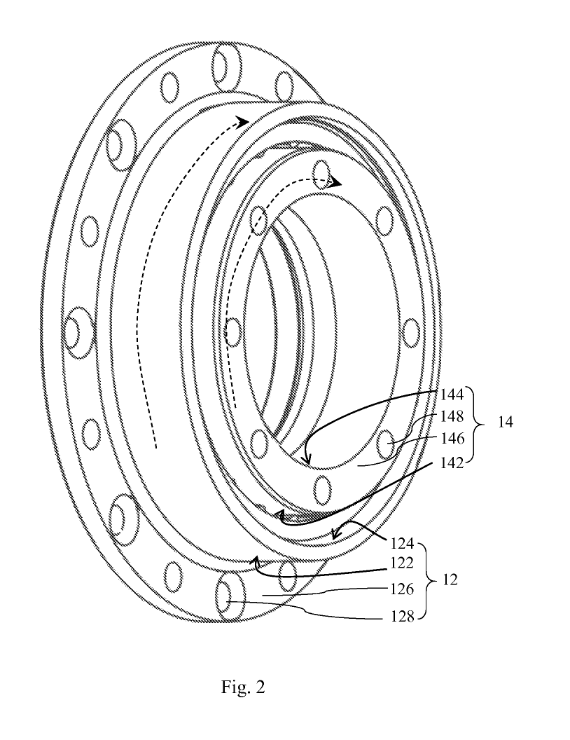

Please refer to FIG. 2, which is a schematic drawing showing a structure of a first one-way bearing in FIG. 1. In FIG. 2, the flange 14 rotates due to the towing of the first ring-shaped body 12 when the first ring-shaped body 12 moves in a clockwise direction. Otherwise, the flange 14 will detach from the towing of the first ring-shaped body 12 if the first ring-shaped body 12 moves in a counterclockwise direction.

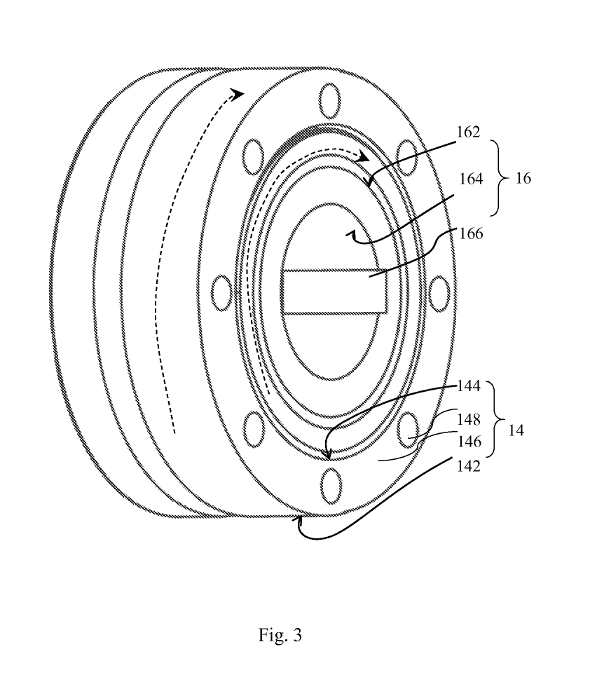

Please refer to FIG. 3, which is a schematic drawing showing a structure of a second one-way bearing in FIG. 1. In FIG. 3, flange 14 rotates due to towing of the second ring-shaped body 16 if the second ring-shaped body 16 moves in a clockwise direction. Otherwise, the flange 14 will detach from the towing of the second ring-shaped body 16 if the second ring-shaped body 16 moves towards a counterclockwise direction.

It is noted that in FIG. 2 and FIG. 3, the coupling method between the first ring-shaped body 12 and the flange 14, or between the flange 14 and the second ring-shaped body 16, can be further distinguished by cylinder roller type, wedge type and cam type according to the type of the inner mechanism. However, there is no need for further description in the present invention.

According to different driving methods and applications, the bearings coordination mechanism operation can be classified to a) a forward operation mode and b) a backward operation mode. The details are illustrates as the following:

a) The Forward Operation Mode

In the forward operation mode, at least one of the first ring-shaped body 12 or the second ring-shaped body 16 of bearings coordination mechanism 10 will be driven by a power source unit (not shown in the figure) to tow flange 14 in rotation towards a direction. Thus, flange 14 outputs a force due to its rotation. In the current presentation, a clockwise direction is taken as the example of the above-mentioned direction. However, a counterclockwise direction is also available in other presentation.

According to the difference between the operations, the forward operation mode can be further divided into the following three operations. They are a first forward operation mode, a second forward operation mode and third forward operation mode.

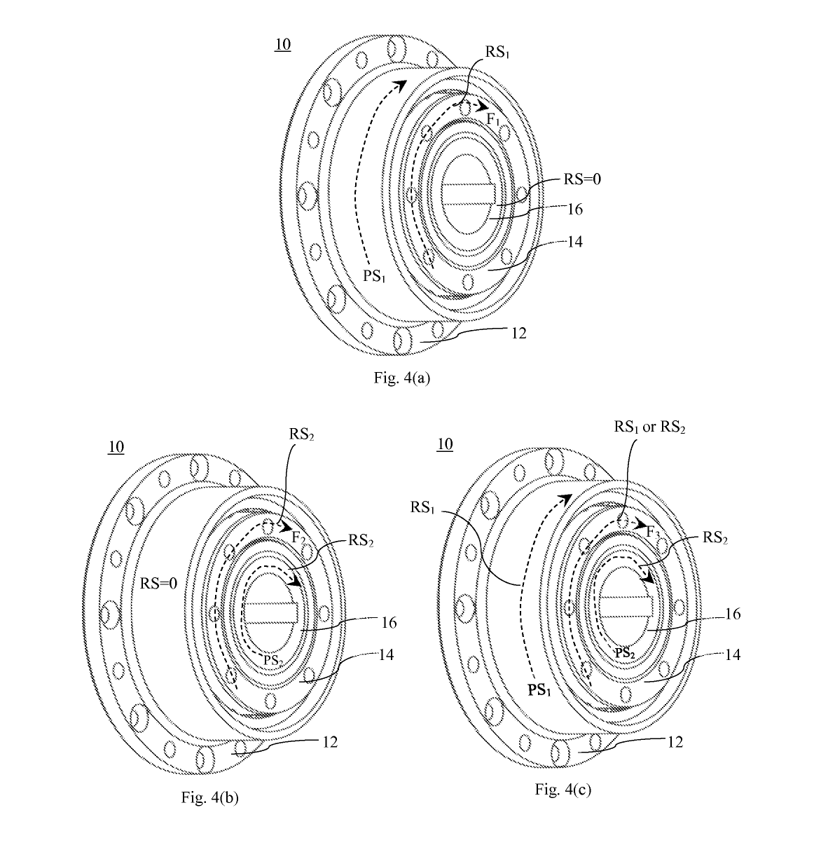

The first forward operation mode is illustrated in conjunction with FIG. 4(a), which is a schematic drawing showing an operation of a first forward operation mode according to the presentation of the bearings coordination mechanism of the present invention. In FIG. 4(a), the first ring-shaped body 12 of the bearings coordination mechanism 10 is connected to a first power source unit (not shown in the figure). The first power source unit outputs a first power source PS₁ to the first ring-shaped body 12, and the first ring-shaped body 12 tows the flange 14 by a first rotating speed RS₁ to drive flange 14 to output a first force F₁.

The second forward operation mode is illustrated in conjunction with FIG. 4(b), which is a schematic drawing showing a second forward operation mode according to the presentation of the bearings coordination mechanism of the present invention. In FIG. 4(b), the second ring-shaped body 16 is connected to a second power source unit (not shown in the figure). The second power source unit outputs a second power source PS₂ to the second ring-shaped body 16, and the second ring-shaped body 16 tows the flange 14 by a second rotating speed RS₂ to drive the flange 14 to output a second force F₂.

The third forward operation mode is illustrated in conjunction with FIG. 4(c), which is a schematic drawing showing an operation of a third forward operation mode according to the presentation of the bearings coordination mechanism of the present invention. In FIG. 4(c), the bearings coordination mechanism 10 is connected to the first power source unit (not shown in the figure) and the second power source unit (not shown in the figure) simultaneously. The power source unit outputs the first power source PS₁ to the first ring-shaped body 12, and the first ring-shaped body 12 tows flange 14 by the first rotating speed RS₁, and the second power source unit outputs the second power source PS₂ to the second ring-shaped body 16, and the second ring-shaped body 16 tows flange 14 by the second rotating speed RS₂. It is noted that the flange 14 is coupled with the first ring-shaped body 12 or the second ring-shaped body 16 according to the higher of the first rotating speed RS₁ or the second rotating speed RS₂ to output a third force F₃. That is, under the third forward operation mode, the ring-shaped body having a higher rotating speed will tow flange 14, and the ring-shaped body having a lower rotating speed cannot tow flange 14.

To sum up the above-mentioned three forward operation modes, the bearings coordination mechanism 10 is connected to a gear module of an electric bicycle (not shown in the figure). The electric bicycle is capable of switching between a motor power source (the first power source PS₁) and a pedal power source (the second source PS₂) as the power source through the bearings coordination mechanism 10 for driving the gear module.

For example, the first ring-shaped body 12 receives the motor power source, the second ring-shaped body 16 receives the pedal power source, and the flange 14 is connected to the gear module. When the first ring-shaped body 12 receives the motor power source and the second ring-shaped body 16 receives the pedal power source, the first ring-shaped body 12 and the second ring-shaped body 16 both have the possibility of towing flange 14. If flange 14 is towed by the first ring-shaped body 12 or the second ring-shaped body 16, the flange 14 outputs the third force F₃ for driving the gear module to allow the electric bicycle to move towards one direction. It should be noted that the bearings coordination mechanism determines which rotating speed performed at the flange, towed by the ring-shaped body, is higher. The bearings coordination mechanism then output the motor power source or the pedal power source by the flange in order to drive the gear module. In other words, the power source can freely switch between the motor power source and the pedal power source to tow flange 14 when the electric bicycle is in use. That is, the motor power source and the pedal power source can be switched without an additional adapting junction parts.

The core of the forward operation mode is that a transmission device can choose one of several power sources to perform the transmission of the force without additional adapting junction parts. In addition to the above-mentioned electric bicycle, the forward operation mode is also applied in, such as, (1) an application field of a hybrid electric roller door to switch a motor power source and a human power source, for (2) an application field of a hybrid generator to switch between a wind power source and a water power source, for (3) an application field of a water pump to switch between a motor and a human power, and for (4) an application field of a motor to switch between a petroleum engine and an electric motor. The above-mentioned application fields are only examples, and the forward operation mode can also be applied in other application fields.

### b) The Backward Operation Mode

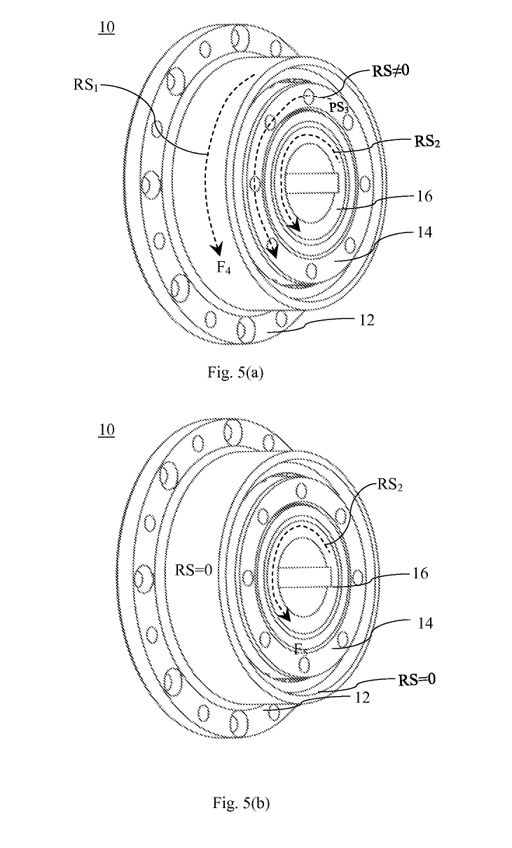

Please refer to FIG. 5(a), which is a schematic drawing showing a first backward operation mode according to the presentation of the bearings coordination mechanism of the present invention. In the schematic drawing of the first operation mode, flange 14 is connected to a third power source unit (not shown in the figure). The third power source unit outputs a third power source PS₃ to the flange 14. The flange 14 moves the first ring-shaped body 12 and the second ring-shaped body 16 simultaneously. The flange 14 drives the first ring-shaped body 12 to rotate by the first rotating speed RS₁ thus output a fourth force F₄, and the flange 14 drives the second ring-shaped body 16 to rotate by the second rotating speed RS₂ thus output a fifth force F₅. A counterclockwise direction is taken as an example of the above-mentioned direction. However, a clockwise direction is also available in other applications.

Another embodiment is illustrated in conjunction with FIG. 5(b), which is a schematic drawing showing a second backward operation mode according to an embodiment of the bearings coordination mechanism of the present invention. In the second operation status, the bearings coordination mechanism 10 not only comprises the third power source unit mentioned in FIG. 5(a) but also comprises a first output roller (not shown in the figure), a first brake unit (not shown in the figure) and a generator (not shown in the figure). The first ring-shaped body 12 is connected to the first output roller, and the first brake unit is provided to reduce the rotating speed of the first output roller. The second ring-shaped body 16 is connected to the generator.

For example, the bearings coordination mechanism can be applied onto a power generating system while a vehicle is braking. When the first ring-shaped body 12 and the second ring-shaped body 16 rotate simultaneously, the first ring-shaped body 12 drives the first output roller to rotate and the second ring-shaped body 16 drives the generator to generate an electric power. If the first brake unit acts on the first output roller, the rotating speed of the first output roller and the first rotating speed RS₁ of the first ring-shaped body 12 will be reduced to zero. At that time, the first ring-shaped body 12 also brakes the flange 14 to allow the rotating speed of the flange 14 to be reduced to zero. However, the second ring-shaped body 16 still rotates and keeps driving the generator to generate the electric power. Now, the operation of the second ring-shaped body 16 is the same as an idle gear.

In addition to the generation of several power sources via a single power source, the core of the backward operation mode can also prevent the second one-way bearing from being affected by the first one-way bearing after the first one-way bearing is stopped.

In addition to the above-mentioned bearings coordination mechanism 10, the present invention further provides a bearings coordination system. The bearings coordination system comprises a first bearings coordination mechanism (not shown in the figure) and a second bearings coordination mechanism (not shown in the figure). The first bearings coordination mechanism comprises a first ring-shaped body, a third ring-shaped body and a first flange. The first ring-shaped body is coupled with the first flange to form a first one-way bearing, and the third ring-shaped body is coupled with the first flange to form a second one-way bearing. The second bearings coordination mechanism comprises a second ring-shaped body, a fourth ring-shaped body and a second flange. The second ring-shaped body is coupled with the second flange to form a third one-way bearing, the fourth ring-shaped body is coupled with the second flange to form a fourth one-way bearing. The bearings coordination system can perform forward and backward operation modes simultaneously by connecting the first flange with the second flange.

For example, the bearings coordination system can be applied for a power generating system by braking of an electric bicycle. The first bearings coordination mechanism is connected to a motor power source and a pedal power source to allow the electric bicycle to receive the input of the motor power source and the pedal power source individually or simultaneously. That is, the first bearings coordination mechanism performs the forward operation mode. The motor power source or the pedal power source outputs a first force F₁ via the first flange of the first one-way bearing or the second one-way bearing. The first flange is connected with the second flange so that the first force F₁ is transmitted to the second flange.

The third one-way bearing is connected to a gear module, and the fourth one-way bearing is connected to a generator. The second flange of the second bearings coordination mechanism receives the first force F₁ so that a second force is outputted at the third one-way bearing and a third force is outputted at the fourth one-way bearing. That is, the second bearings coordination mechanism performs the backward operation mode.

When the second bearings coordination mechanism continuously receives the first force F₁, the third one-way bearing outputs the second force to allow the electric bicycle to move towards a direction. Furthermore, the fourth one-way bearing outputs the third force to drive the generator.

When the electric bicycle performs a braking action by a brake unit, the electric bicycle will slow down or stop. However, the fourth ring-shaped body of the fourth one-way bearing still drives the generator continuously within a period.

In another embodiment, the first flange and the second flange is capable of forming a joint flange.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

1. A bearings coordination mechanism, comprising:
a first ring-shaped body forming a first accommodating space;
a flange forming a second accommodating space, wherein the flange is positioned in the first accommodating space;
a second ring-shaped body positioned in the second accommodating space;
wherein an outer side of the flange is coupled with an inner side of the first ring-shaped body in a single direction to form a first one-way bearing and an inner side of the flange is coupled with an outer side of the second ring-shaped body in the single direction to form a second one-way bearing.

2. The bearings coordination mechanism according to claim 1, wherein the first ring-shaped body is connected to a first power source unit in which the first power source unit outputs a first power source to the first ring-shaped body to drive the first ring-shaped body to tow the flange by a first rotating speed and output a first force at the flange.

3. The bearings coordination mechanism according to claim 1, wherein the second ring-shaped body is connected to a second power source unit in which the second power source unit outputs a second power source to the second ring-shaped body to drive the second ring-shaped body to tow the flange by a second rotating speed and output a second force at the flange.

4. The bearings coordination mechanism according to claim 1, wherein the first ring-shaped body is connected to a first power source unit in which the first power source unit outputs a first power source to the first ring-shaped body to drive the first ring-shaped body to tow the flange by a first rotating speed, the second ring-shaped body is connected to a second power source unit in which the second power source unit outputs a second power source to the second ring-shaped body to drive the second ring-shaped body to tow the flange by a second rotating speed and the flange is towed by the first ring-shaped body or the second ring-shaped body according to the larger of the first rotating speed or the second rotating speed to output a third force thereat.

5. The bearings coordination mechanism according to claim 1, wherein the flange is connected to a third power source unit in which the third power source unit outputs a third power source to the flange and the flange tows the first ring-shaped body and the second ring-shaped body at the same time to drive the first ring-shaped body to rotate by a first rotating speed and to drive the second ring-shaped body to rotate by a second rotating speed.

6. The bearings coordination mechanism according to claim 5 further comprising a first brake unit and a first output roller, wherein the first brake unit is coupled with the first output roller, the first output roller is connected to the first ring-shaped body, the first brake unit applies a first brake force to the first output roller for reducing a rotating speed of the first output roller and the first rotating speed of the first ring-shaped body, the first ring-shaped body reduces a rotating speed of the flange but the flange does not reduce the second rotating speed of the second ring-shaped body.

7. The bearings coordination mechanism according to claim 5 further comprising a second brake unit and a second output roller, wherein the second brake unit is coupled to the second output roller, the second output roller is connected to the second ring-shaped body, the second brake unit applies a second brake force to the second output roller for reducing a rotating speed of the second output roller and the second rotating speed of the second ring-shaped body but the flange does not reduce the first rotating speed of the first ring-shaped body.

8. A bearings coordination system, comprising:
a first bearings coordination mechanism having a first ring-shaped body, a third ring-shaped body and a first flange, wherein the first ring-shaped body is coupled with the first flange to form a first one-way bearing and the third ring-shaped body which is coupled with the first flange to form a second one-way bearing; and
a second bearings coordination mechanism having a second ring-shaped body, a fourth ring-shaped body and a second flange in which the second ring-shaped body is coupled with the second flange to form a third one-way bearing, the fourth ring-shaped body is coupled with the second flange to form a fourth one-way bearing and the second flange is connected to the first flange,
wherein one of the first one-way bearing or the second one-way bearing outputs a first force to the third one-way bearing and the fourth one-way bearing to allow the third one-way bearing to output a second force and to allow the fourth one-way bearing to output a third force.

9. The bearings coordination system according to claim 8, wherein the first flange and the second flange is capable of forming a joint flange.
